(19) United States
(12) Patent Application Publication
(10) Pub. No.: US 2006/0037980 A1
(43) Pub. Date: Feb. 23, 2006

(54) Discharge assembly for flowable material in a container

(75) Inventor: Mark Nepil, Carpentersville, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Keson Industries

(21) Appl. No.: 10/921,713

(22) Filed: Aug. 19, 2004

(51) Int. Cl. B44D 3/38

(52) U.S. Cl. 222/566; 222/575; 33/414

(57) ABSTRACT

A discharge assembly for a container having a housing bounding a storage space for flowable material and a first discharge opening A connecting portion maintains the discharge assembly on the container housing. The discharge portion has an annular inside surface that tapers in diameter from the connecting portion toward a free end. The inside surface has a stepped shape at a first axial location so as to define a larger diameter portion and a smaller diameter portion. The annular wall is cuttable to define a first cut end at the larger diameter portion at which a second discharge opening can be formed. The annular wall at least one of (a) has a third opening at the free end and (b) is cuttable generally along a plane to define a second cut end at the smaller diameter portion at which a third discharge opening can be formed.

### BACKGROUND OF THE INVENTION

1. Field of the Invention

This invention relates to containers for flowable bulk materials and, more particularly, to an assembly for controlling the discharge of the materials from the containers.

2. Background Art

In many different industries, flowable material, either in liquid or particulate form, is stored in portable containers. As one example, in the construction industry, bulk supplies of powdered chalk are stored in containers for discharge by a user at sites at which the chalk is to be used. Typically, the chalk is dispensed into a storage space defined by a housing on a hand-holdable chalk line reel. A flexible line is wrapped around a spool within the storage space and immersed in a supply of chalk. As the line is drawn off of the spool, it is coated with the chalk in such a manner that the line can be conventionally drawn taut and “snapped” to transfer the chalk from the line to an adjacent surface for appropriate marking thereof.

Chalk line reel housings are generally made to be holdable conveniently in the hand of a user. This configuration of chalk line reel has been highly commercially successful and continues to be used today, but is limited with respect to the length of line and volume of chalk that can be accommodated.

In this conventional design, typically a fill opening is provided in the housing in communication with the storage space. The fill opening receives a resilient plug/grommet which blocks the fill opening. The plug/grommet has a thin wall/membrane with crossed cuts therethrough that allow penetration by a tapered spout on a discharge assembly attached to the bulk chalk container. The crossed cuts produce deformable flaps which will bend as they are impacted by the tapered spout and will reassume a sealed state once the spout is withdrawn.

Typically, the plugs/grommets and associated cuts are configured to accommodate a relatively small diameter of spout. Discharge assemblies for bulk chalk containers, to be universal in nature, are designed for the smallest size of chalk line reel. Typically, the spout on the discharge assembly tapers continuously from a connecting portion, which attaches to the bulk chalk container, to a point or relatively small diameter at a free discharge end. The spout portion is made from a material that can be cut at different axial locations to change the effective diameter of the discharge opening on the spout. Heretofore, the spouts have been designed with a constant taper angle between the connecting portion and the discharge end. To provide a relatively pointed configuration for the spout and thereby facilitate direction thereof through a slit plug/grommet, the taper angle has been relatively small, as a result of which the range of available diameters for the discharge opening is relatively limited. This range could be increased by increasing the axial length of the spout. However, to produce any appreciable increase in the range of diameters for the discharge opening, the spout would have to be made impractically long in an axial direction.

The assignee herein in recent years began offering a line of chalk line reels with a substantially greater capacity for line and chalk. The conventional slit plug/grommet has been utilized at the fill opening and has been configured to accommodate the aforementioned, conventional spout configuration on the discharge assembly for the bulk material container. The exercise of emptying an entire container of chalk through a fairly small diameter discharge opening may be time consuming, and at times frustrating to the user. This may ultimately lead the user to remove the discharge assembly altogether and try to funnel the chalk from the larger discharge opening in the container into the fill opening on the housing of the chalk line reel. This may result in spilling of a substantial amount of the chalk during this process. As a result, the chalk may be spread undesirably over the surrounding work area. Loss of a substantial amount of the chalk has obvious economic consequences.

### SUMMARY OF THE INVENTION

In one form, the invention is directed to a discharge assembly for a flowable material on a container having a housing with a wall bounding a storage space for flowable material and a fill opening in communication with the storage space. The discharge assembly has a body defining a connecting portion and a discharge portion. The connecting portion maintains the discharge assembly on the container housing. The discharge portion has an annular wall with an annular inside surface having at least a portion with a diameter that tapers along a central axis in a direction from the connecting portion toward a free end to guide flowable material for discharge toward the free end. The inside surface of the annular wall has a stepped shape at a first axial location, as viewed in cross section defined by a plane containing the central axis, so as to define a larger diameter portion between the first location and the connecting portion and a smaller diameter portion between the first location and the free end. The annular wall is cuttable generally along a plane transversely to the central axis to define a first cut end at the larger diameter portion of the inside surface at which a first discharge opening with a first effective diameter can be formed. The annular wall at least one of (a) has a second discharge opening at the free end with a second effective diameter and (b) is cuttable generally along a plane transversely to the central axis to define a second cut end at the smaller diameter portion of the inside surface at which a third discharge opening with a third effective diameter can be formed.

The discharge assembly may be provided in combination with a container having a housing with a wall bounding a storage space for a flowable material on which the discharge assembly is maintained.

The discharge assembly and container may be further provided in combination with a supply of flowable material, which may be liquid or solid, with the latter in one exemplary form being chalk.

The discharge assembly may be permanently or releasably maintained on the container housing.

In one form, the container housing has an annular neck defining a discharge opening and the connecting portion of the discharge assembly is releasably connected to the annular neck to maintain the discharge assembly on the container housing.

There may be cooperating threads on the connecting portion and the annular neck to allow the discharge assembly to be releasably maintained on the container housing.

The discharge assembly may be provided in combination with a closure cap that can be releasably maintained in an operative position on the discharge assembly to one of (a) block discharge of the flowable material through the second discharge opening and (b) capture flowable material discharged through the first, second, and third discharge openings.

The closure cap may be releasably snap fit to the annular wall on the discharge assembly.

In one form, the annular wall has an outside surface with a first shoulder that faces in a first axial direction and the closure cap has an inside surface with a second shoulder that faces axially oppositely to the first axial direction with the closure cap in the operative position and confronts the first shoulder to resist relative axial movement of the closure cap and the discharge assembly tending to change the closure cap from the operative position.

In one form, at least a part of at least one of the closure cap and discharge assembly is deformable to allow the closure cap and discharge assembly to be relatively axially moved between a fully separated state and a relative axial position wherein the closure cap is in the operative position by movement of the first and second shoulders towards and past each other into a confronting relationship.

In one form, each of the first and second shoulders has an annular shape around the central axis.

In one form, the annular wall on the discharge assembly has an outside surface with at least a potion having a diameter that tapers along the central axis in a direction from the connecting portion toward the free end. The outside surface has a stepped shape at a second location, as viewed in cross section defined by a plane containing the central axis, so as to define a second larger diameter portion between the second location and the connecting portion and a second smaller diameter portion between the second location and the free end. With the closure cap in the operative position, the cap closure extends continuously from the free end to axially over at least a portion of the second larger diameter portion.

In one form, the inside and outside surfaces of the annular wall have a conforming shape along substantially the entire axial extent of the annular wall.

The annular wall may have a substantially uniform radial thickness along substantially the entire axial extent of the annular wall.

The annular wall may be made from a plastic material.

The plastic material may be translucent.

In one form, the annular wall has a first visible guide line formed thereon in axial coincidence with the larger diameter portion of the inside surface along which the annular wall can be cut to produce a predetermined diameter for the first discharge opening.

In one form, the annular wall has a second visible guide line formed thereon in axial coincidence with the smaller diameter portion of the inside surface along which the annular wall can be cut to produce a predetermined diameter for the third discharge opening.

The closure cap may be made from a plastic material.

In one form, the inside surface has a first taper angle at the smaller diameter portion and a second taper angle at the larger diameter portion, with the first and second taper angles being approximately equal.

In one form, the first visible guide line and/or the second visible guide line is defined by an annular shoulder.

The invention is further directed to a discharge assembly for a flowable material in a container having a housing with a wall bounding a storage space for flowable material and a fill opening in communication with the storage space. The discharge assembly has a body defining a connecting portion and a discharge portion. The connecting portion maintains the discharge assembly on the container housing. The discharge portion has an annular wall with an annular inside surface that has a stepped shape at a first location, as viewed in cross section defined by a plane containing the central axis, so as to define a larger diameter portion between the first location and the connecting portion and a smaller diameter portion between the first location and the free end. The annular wall is cuttable generally along a plane transversely to the central axis to define a first cut end at the larger diameter portion of the inside surface at which a first discharge opening with a first effective diameter can be formed. The annular wall at least one of (a) has a second discharge opening at the free end with a second effective diameter and (b) is cuttable generally along a plane transversely to the central axis to define a second cut end at the smaller diameter portion of the inside surface at which a third discharge opening with a third effective diameter can be formed.

The discharge assembly may be provided in combination with a container having a housing with a wall bounding a storage space for a flowable material on which the discharge assembly is maintained.

The discharge assembly and container may be provided in combination with a supply of flowable material.

The flowable material may be in liquid or solid form and, in the latter case, may be in the form of a powered chalk.

The discharge assembly may be provided in combination with a closure cap that can be releasably maintained in an operative position on the discharge assembly to one of (a) block discharge of flowable material through the second discharge opening and (b) capture flowable material discharged through the first, second, and third discharge openings.

The closure cap may be releasably snap fit to the annular wall on the discharge assembly.

### BRIEF DESCRIPTION OF THE DRAWINGS

FIG. 1 is a side elevation view of a prior art chalk line reel with a housing that is operatively held in the hand of a user and including a plug/grommet which blocks a fill opening in the housing;

FIG. 2 is a fragmentary, cross-sectional view of the plug/grommet on the chalk line reel in FIG. 1 and with a conventional discharge assembly directed through the plug/grommet and attached to a container with a bulk supply of chalk which can be communicated from the container through the discharge assembly to a storage space within the chalk line reel housing;

FIG. 3 is a side elevation view of another form of conventional chalk line reel having a larger storage capacity for chalk than the chalk line reel in FIG. 1;

FIG. 4 is a side elevation view of the chalk line reel in FIG. 3;

FIG. 5 is a reduced, elevation view of a further modified form of container, having a larger capacity than the container in FIG. 2, and incorporating the discharge assembly shown in FIG. 2;

FIG. 6 is an exploded, partially schematic, side elevation view of a discharge assembly, according to the present invention, operatively connected to a container, as in FIGS. 2 and 5, and in association with a closure cap for blocking passage of flowable material through the discharge assembly for use thereof;

FIG. 7 is a cross-sectional view of the discharge assembly taken along line 7-7 of FIG. 6 and with the closure cap shown in phantom lines in an operative position;

FIG. 8 is a view as in FIG. 7 with a tapering annular wall on the discharge assembly cut off to define a discharge opening having a larger diameter than shown in FIG. 7 and with the closure cap shown in phantom lines in the operative position;

FIG. 9 is a view as in FIG. 8 with the annular wall cut off at a different axial location to further change the diameter of the discharge opening;

FIG. 10 is an enlarged, fragmentary, cross-sectional view showing annular beads on the closure cap and annular wall of the inventive discharge assembly which produce a snap-fit connection between the closure cap and the discharge assembly and with the beads being moved axially toward each other as the discharge assembly and closure cap are moved relative to each other in the axial direction;

FIG. 11 is a view as in FIG. 10 with the beads moved axially against each other and radially deformed;

FIG. 12 is a view as in FIG. 11 wherein the beads have been moved past each other and the closure cap is in the operative position;

FIG. 13 is a fragmentary, cross-sectional view of a modified form of discharge end on the discharge assembly in FIG. 6, wherein the free end thereof is closed;

FIG. 14 is a view as in FIG. 6 of a modified form of discharge assembly, according to the present invention;

FIG. 15 is a view as in FIG. 14 of a still further modified form of discharge assembly, according to the present invention;

FIG. 16 is a view as in FIGS. 14 and 15 of a still further modified form of discharge assembly, according to the present invention;

FIG. 17 is a fragmentary view, similar to that in FIG. 9, of a modified form of discharge assembly, according to the invention, including a weakening portion on an annular wall which allows a portion of the annular wall to be separated at a predetermined axial location to change the diameter of a discharge opening;

FIG. 18 is a fragmentary view of a portion of the annular wall in FIG. 17 with the annular wall fractured at the weakening portion thereon;

FIG. 19 is a schematic representation of one form of combination of container and discharge assembly, with the discharge assembly separately attached thereto, according to the present invention;

FIG. 20 is a view as in FIG. 19 with the discharge assembly integral with or permanently attached to the container; and

FIG. 21 is a schematic representation of a kit, according to the present invention, including a chalk line reel, a container with a supply of chalk, and a discharge assembly which can be releasably attached to or permanently formed with the container.

### DETAILED DESCRIPTION OF THE DRAWINGS

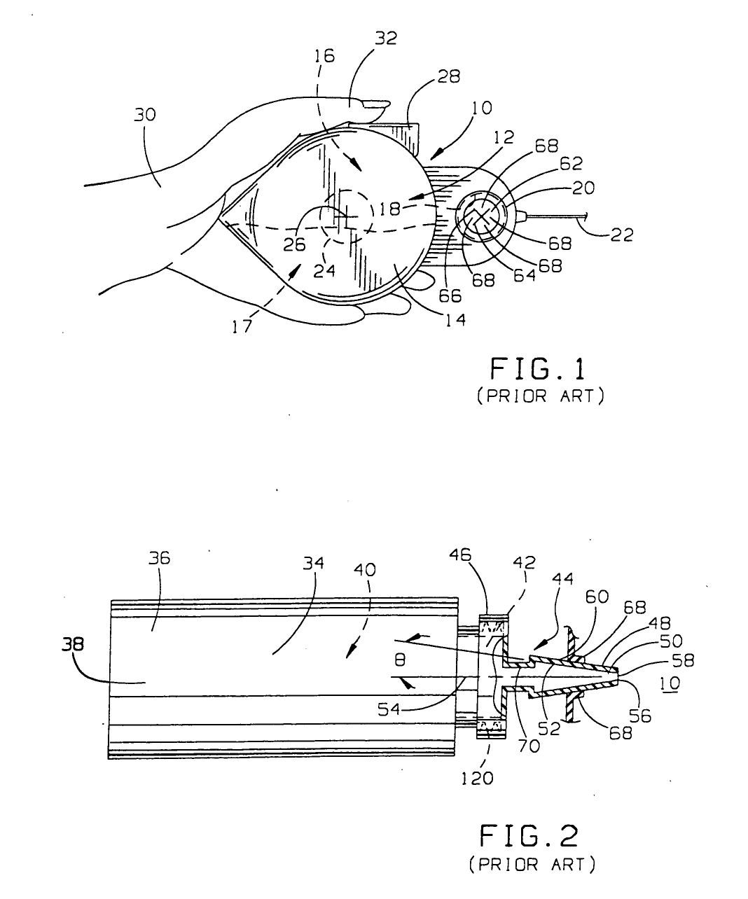

In FIGS. 1 and 2, a conventional chalk line reel is shown at 10 and includes a housing 12 with a wall 14 bounding a storage space 16 within which a supply of chalk 17 is contained. The chalk 17 is introduced to the storage space 16 through a fill opening 18 defined through the housing wall 14. The fill opening 18 is blocked by a plug/grommet 20 that is compressibly squeezed within the fill opening 18 and maintained in place by captively engaging the thickness of the wall 14 through an arrangement which is not shown in detail in FIGS. 1 and 2. A supply of flexible line 22 is wrapped around a spool 24 that is rotatable about an axis 26 within the storage space 16. The embodiment shown in FIGS. 1 and 2 is similar to one sold commercially by the assignee herein under the trademark “SPEEDEMON”. This unit has a spring biasing mechanism that urges the spool 24 in rotation around the axis 26 so as to retrieve the flexible line 22 by wrapping the line 22 on the spool. 24. A braking force, normally applied to the spool 24, is released through a thumb button 28 to allow the spring bias mechanism to rotate the spool 24 and thereby retrieve the flexible line 22 to the desired extent. By depressing the thumb button 28, the line 22 can be pulled off of the spool 24 to the desired length.

This type of chalk line reel is designed to be conveniently grasped and held by a single hand 30 of a user in the manner shown in FIG. 1. In this grasping position, the user's thumb 32 is conveniently situated to depress and release the thumb button 28 to selectively effect braking of the spool rotation. Given the compact configuration of the housing 12, the storage space 16 has a relatively limited volume which will generally accommodate only a few ounces of chalk. The assignee herein currently offers a bulk chalk supply container 34, as shown in FIG. 2, with a housing 36 having a wall 38 bounding a storage space 40 that will accommodate approximately eight ounces of chalk. The housing 36 has an integral neck 42 to which a discharge assembly at 44 is releasably connected, as by threads or a snap-fit arrangement.

The discharge assembly 44 has a connecting portion 46 and a discharging portion 48. The discharging portion 48 has a spout with an annular wall 50 with an annular inside surface 52 that tapers in diameter along a central axis 54 along a portion thereof in a direction from the connecting portion 46 towards a free end 56. A discharge opening 58 is provided at the free end 56. The inside surface 52 makes an angle θ with the axis 54 that remains substantially constant over the entire tapered portion of the inside surface 52. The annular wall 50 has an outside surface 60 that has a corresponding taper angle θ with respect to the axis 54.

The outside surface 60 is designed with a profile to facilitate a sealed penetration of the plug/grommet 20 by a spout to allow introduction of the chalk therethrough from the container 34 into the storage space 16 defined by the housing 12. To accommodate the spouts, the plug/grommet 20 has a thin wall portion/membrane 62 with cross slits 64,66 therethrough defining V-shaped flaps 68. By directing the free end 56 of the discharge assembly 44 against the thin wall portion/membrane 62, the flaps 68 deflect inwardly and surroundingly conform to the outside surface 60 to produce a conforming opening for the annular wall 50. With this arrangement, a continuous communication passageway 70 is defined from the storage space 40 through the discharge assembly 44 and into the storage space 16 on the chalk line reel 10.

It is known to cut the annular wall 50 in a plane generally orthogonal to the axis 54 to change the axial location of the free end of the annular wall 50 and thereby the effective diameter of the discharge opening produced thereat by reason of the tapering of the inside surface 52. Visible guide lines (not shown) assist the user in selecting an appropriate axial location at which a cut should be made, depending upon the desired discharge opening diameter. Because the angle θ is relatively small to produce a relatively thin profile to facilitate penetration of the plug/grommet 20, the range of diameters for the discharge openings that can be produced by selectively cutting the annular wall at different axial locations is limited. A larger range of diameters could be made possible by substantially extending the axial length of the annular wall 50. However, this undesirably increases the axial length of the overall discharge assembly 44.

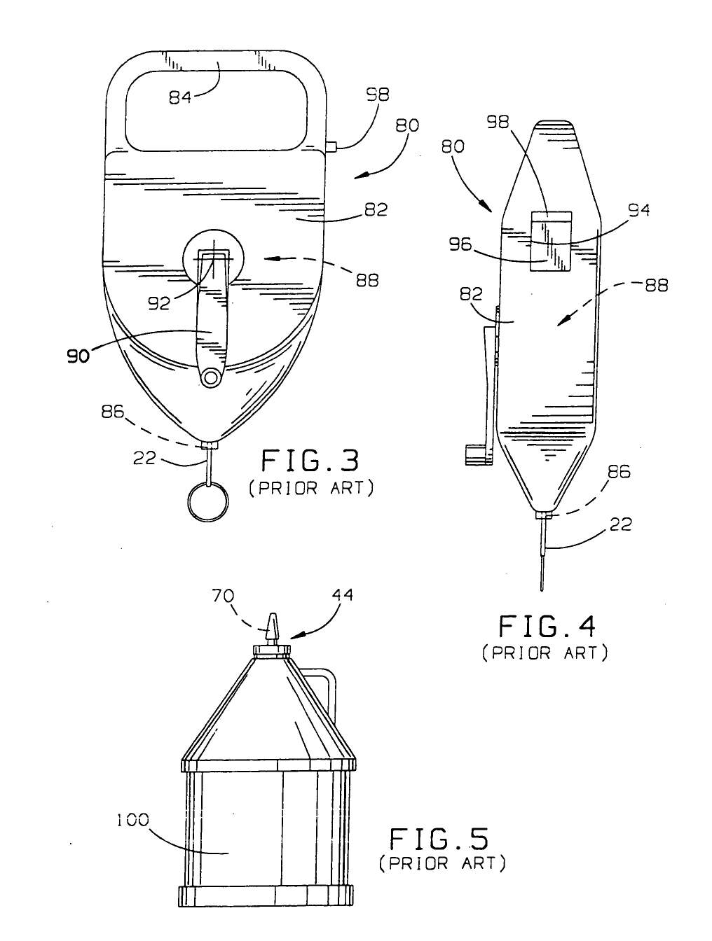

The assignee has been commercially selling chalk line reels, having a significantly larger line and chalk capacity, under the trademark “GIANT”. One exemplary form of these larger chalk line reels is shown at 80 in FIGS. 3 and 4. The chalk line reel 80 has a housing 82 with a graspable handle portion 84 remote from an opening 86 through which flexible line 22 passes from a supply thereof within a storage space 88 defined by the housing 82. The line 22 is retrieved by manually moving a handle 90 around an axis 92 to wrap the flexible line 22 around a spool (not shown).

Chalk is introduced to the storage space 88 through a fill opening 94 through the housing 82. The fill opening 94 has a substantially rectangular shape and is selectively closed and exposed by repositioning a slidable door 96 which can be manipulated by grasping and moving a tab 98 thereon.

Since the housing 82 is capable of accommodating a larger quantity of chalk, the assignee has offered a larger container for bulk chalk supply, as shown at 100 in FIG. 5. The container 100 utilizes the same configuration of discharge assembly 44, as previously described. By reason of the relatively small diameter of the passageway 70 on the discharge assembly 44, it may be inconveniently time consuming to dispense the desired amount of chalk from the container 100 into the storage space 88 on the chalk line reel 80.

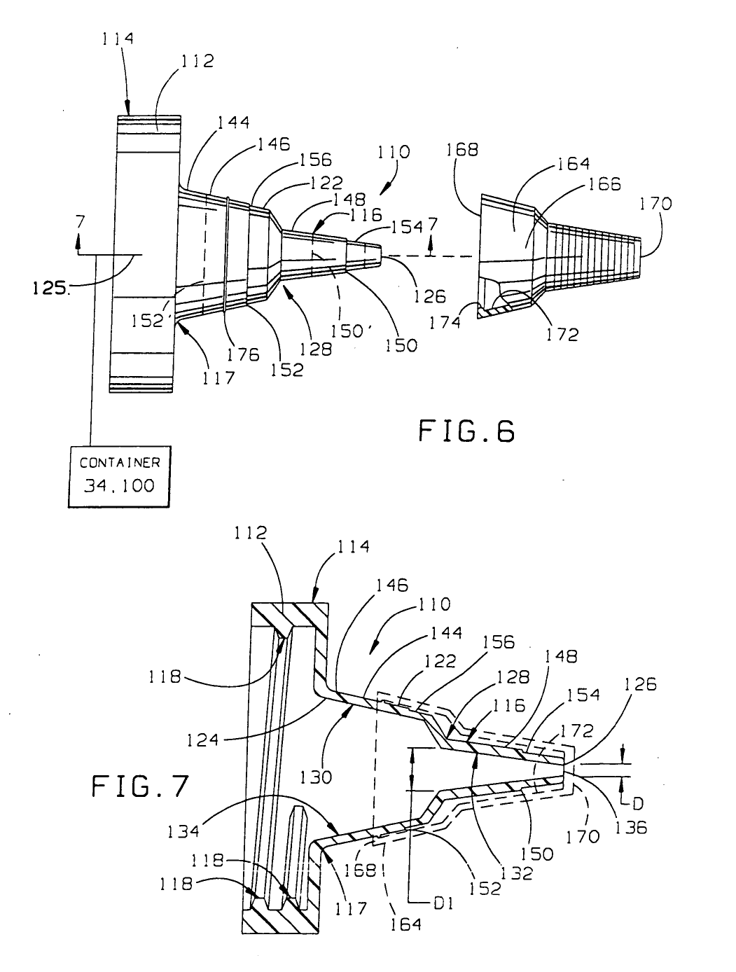

Referring now to FIGS. 6-9, one form of discharge assembly, according to the present invention, for use in association with containers as shown at 34,100, is shown at 110. The discharge assembly 110 has a body 112 with a connecting portion 114 and a spout/discharge portion 116. The discharge portion 116 and connecting portion 114 meet at a radiused juncture at 117. This radiused arrangement distributes axial forces applied to the discharge portion 116 that otherwise might be locally applied to potentially cause a fracture at the juncture 117. This axial loading may be encountered when cases of the container 34,100 are stacked, one on top of the other.

The connecting portion 114 has one or more ribs, or threads 118, which cooperate with one or more ribs/threads 120 (FIG. 2) on the container 34,100 to allow the discharge assembly 110 to be either snap fit to or threadably engaged with, the neck 42 (FIG. 2) on the container 34,100. The manner by which the discharge assembly 110 is connected to the container 34,100 is not critical to the present invention.

The discharge portion 116 has an annular wall 122 with an annular inside surface 124 that tapers in diameter along a central axis 125 in a direction from the connecting portion 114 towards a free end 126, to guide flowable material for discharge toward the free end 126.

As viewed in cross section, defined by a plane containing the central axis, as shown in FIGS. 7-9, the inside surface 124 has a stepped shape, at a first location 128, so as to define a larger diameter portion 130 between the first location 128 and the connecting portion 114 and a smaller diameter portion 132 between the first location 128 and the free end 126.

With the configuration shown, the discharge assembly 110 defines a continuous passageway 134 between the container 34,100 and the free end 126. At the free end 126, the passageway 134 has a discharge opening 136 with a diameter D. The annular wall 122 is preferably made from a material that can be readily cut, as by a utility knife or a saw. A suitable material is a plastic, such as polyethylene, which may be translucent to allow the user to observe the passage of the chalk therethrough.

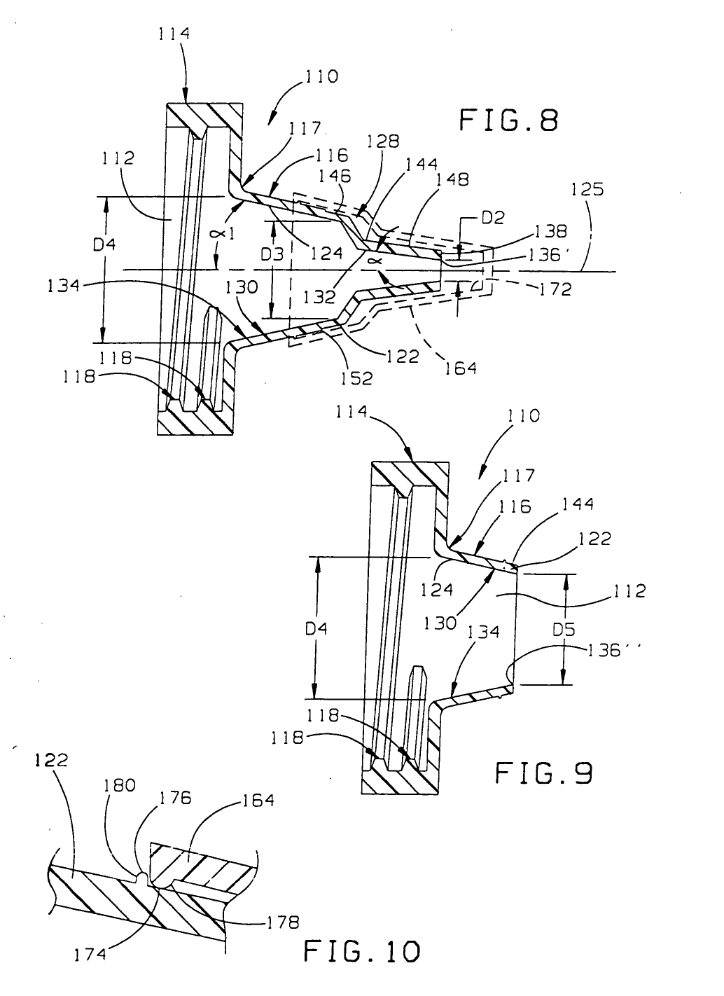

The annular wall 122 can be cut at different axial locations coinciding with the smaller diameter portion 132 of the inside surface 124. By cutting the annular wall along a plane transversely to the central axis 125 that coincides with the smaller diameter portion 132 of the inside surface 124, cut free ends are defined with discharge openings having diameters varying from the aforementioned diameter D to a maximum diameter D1, as shown in FIG. 7 at the first location 128. For example, as shown in FIG. 8, the annular wall 122 is cut at an axial location approximately midway between the free end 126 and the first location 128 to produce a cut free end 138 with a discharge opening 136′ having a diameter D2, that is greater than the diameter D but less than the diameter D1.

At the step at the first location 128, there is a gross change in the diameter of the inside surface 124 between the smaller diameter portion 132 and the larger diameter portion 130. By cutting the annular wall 122 to coincide with the larger diameter portion 130 of the inside surface 124, a cut free end can be formed to produce a discharge opening thereat that ranges in diameter from a diameter D3, as shown adjacent to the stepped portion at the first location 128, to a diameter D4 at the connecting portion 114 (FIG. 8). As shown in FIG. 9, by cutting the annular wall 122 midway between the first location 128 and connecting portion 114, a discharge opening 136″ can be formed with a diameter D5, that is greater than the diameter D3 but less than the diameter D4.

With the inventive structure, the user is allowed to cut the annular wall 122 strategically in axial alignment with the larger and smaller diameter portions 130,132 of the inside surface 124, to make a gross selection of larger and smaller diameters for the resulting discharge opening. Within the gross larger and smaller ranges, fine adjustments can be made along the axial extent of the larger diameter portion 130 and smaller diameter portion 132 of the inside surface 124. When it is desired to discharge in smaller volumes, and to have a relatively sharp profile to penetrate part of a chalk line reel, the annular wall 122 can be cut at an axial location coinciding with the smaller diameter portion 132 of the annular wall 122. Similarly, when a larger volume discharge is desired, the annular wall 122 can be cut at an axial location to coincide with the larger diameter portion 130 of the inside surface 124. This arrangement allows a relatively wide range of flow volumes to be selected with a discharge assembly 110 that has a relatively short axial extent. In the absence of the stepped arrangement, the annular wall 122 would have to be substantially longer in an axial direction to make possible the same range of diameters for the discharge openings.

In this embodiment, the annular wall 122 has a substantially uniform thickness along its entire axial extent. As a result, the annular wall 122 has an outside surface 144 with a larger diameter portion 146 and smaller diameter portion 148 axially coinciding respectively with the larger diameter portion 130 and smaller diameter portion 132 of the inside surface 124.

In this embodiment, the smaller diameter portion 132 of the inside surface 124 makes an angle α (FIG. 8) with respect to the central axis 125, with the larger diameter portion 130 of the inside surface 124 making a corresponding angle α1 with the axis 125. The angles α and α1 may be the same or different. In the embodiment shown, they are approximately the same. The larger diameter portion 146 and smaller diameter portion 148 of the outside surface 144 may be aligned at corresponding angles with respect to the axis 125. However, it is not necessary that the outside surface 144 conform in configuration to the inside surface 124.

To facilitate cutting of the annular wall 122, to produce discharge openings 136 of different desired diameters, visible guide lines 150,152 are provided. In this case, the guide line 150 is defined by an undercut 154 in the smaller diameter surface portion 148, with the guide line 152 defined likewise by an undercut 156 in the larger diameter portion 146 of the outside surface 144. The guide lines 150,152 can be strategically located to allow the user to predetermine the diameter of the discharge opening that results by reason of cutting along the particular guide line 150,152.

It is not necessary that the annular wall 122 be undercut to define the guide lines. As shown, for example in FIG. 6, optional guide lines 150′, 152′ can be formed by an applied visible marking, such as through a decal or paint. Any number of guide lines can be provided at different axial locations. It is preferred that the guide lines 150,152,150′,152′ extend continuously around the axis 125 to guide cutting by the user fully around the annular wall 122.

As shown in FIGS. 6-8, the invention also contemplates the optional use of a closure cap 164. The closure cap 164 has a body 166 with an open end 168 and a closed end 170. The closure cap 164 has a stepped inside surface 172 that conforms nominally to the stepped outside surface 144 of the annular wall 122. With the closure cap 164 in the operative position of FIGS. 7 and 8, the open end 168 of the closure cap 164 extends from the free end 126 to a midportion of the axial extent of the larger diameter portion 146 of the outside surface 144. With the closure cap 164 in the operative position, the closed end 170 resides adjacent to the free end 126 of the annular wall 122.

The closure cap 164 has an annular, inwardly projecting bead 174 which cooperates with an annular bead 176, projecting outwardly from the annular wall 122 at the larger diameter portion 146 at the outside surface 144. As seen also with reference to FIGS. 10-12, the closure cap 164 can be changed from a separated state, as shown in FIG. 6, to the operative position shown in FIGS. 7 and 8, through a snap-fit assembly process effected by relatively axially moving the discharge assembly 110 and closure cap 164.

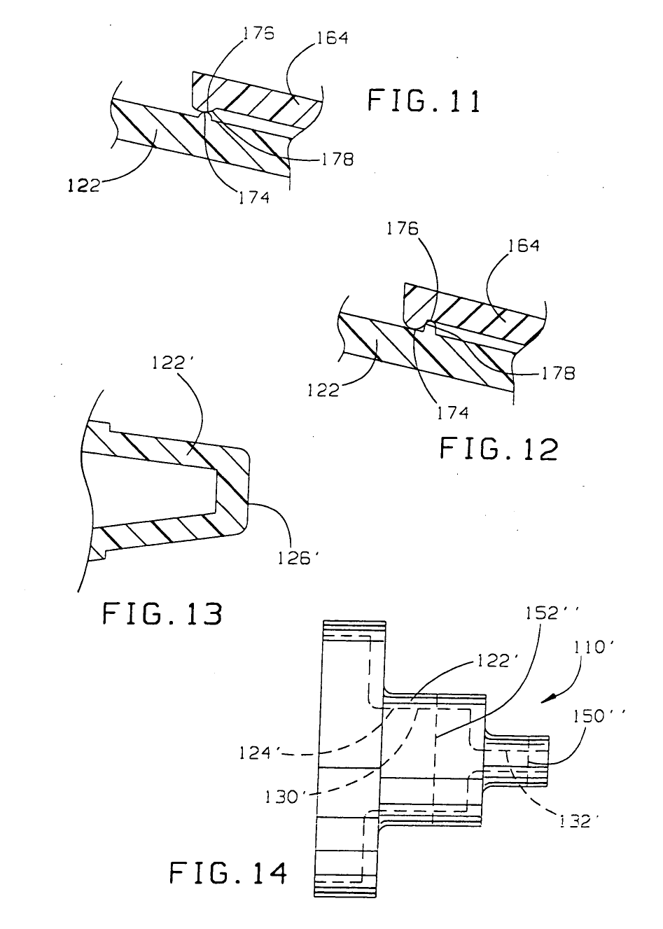

As seen in FIG. 10, as the discharge assembly 110 is directed into the closure cap 164 and the discharge assembly 110 and closure cap 164 are moved axially towards each other, the bead 174 on the closure cap 164 encounters the bead 176 on the annular wall 122. At least one of the closure cap 164 and annular wall 122 has a portion that is radially deformable to allow the beads 174,176 to move against and past each other to the FIG. 12 state, wherein the closure cap 164 is in the operative position. In this embodiment, as shown in FIG. 11, both beads 174,176 are deformable to allow them to be flattened to allow the relationship of FIG. 12 to be attained.

With the closure cap 164 in the operative position, an annular shoulder 178 on the bead 174, facing in one axial direction, confronts an annular shoulder 180 on the annular wall 122, facing axially oppositely to the direction that the annular shoulder 178 faces. Once the closure cap 164 is snap fit into its operative position and can be separated from the discharge assembly 110 by exerting a force sufficient to deform the beads 174,176 to allow the beads 174,176 to compress radially and pass each other by moving axially oppositely to their respective assembly directions.

With the closure cap 164 in its operative position, the closed end 170 of the closure cap 164 is situated to either block the discharge opening 136 or is situated in close proximity thereto so that a limited quantity of chalk can be discharged and is confined by the closure cap 164. Once the annular wall 122 is cut, the operatively positioned closure cap 164 defines, in a similar manner, a receptacle for a discrete, discharged quantity of chalk from the discharge opening 136′, 136″, so that discharge of chalk is eventually altogether blocked after the available volume within the closure cap 164 is filled with chalk.

The invention contemplates many variations from the basic structure described above. Some different variations, which are not intended to be exhaustive of the number of variations contemplated, are described below. As shown in FIG. 13, the free end 126′ of a corresponding annular wall 122′ can be closed at the time of initial manufacture. This requires that the user cut the annular wall 122′ before any chalk can be discharged. This configuration may be desirable to facilitate shipping of the product in a state without requiring the installation of the closure 164.

As shown in FIG. 14, a modified form of discharge assembly 110′ is shown wherein corresponding larger diameter portions 130′ and smaller diameter portions 132′ of an inside surface 124′ each have a constant diameter over their axial extent. As a result, two substantially different volume selections can be made by cutting the annular wall 122′ at axial locations coinciding with the larger and smaller diameter portions 130,132′ of the inside surface 124′. Exemplary visible guide lines 150″, 152″ are incorporated to facilitate cutting of the annular wall 122′.

In FIG. 15, a further modified form of discharge assembly is shown at 110″ with an annular wall 122″ having diameter changing steps, with one such step at a corresponding first location 128′, and additional steps provided at axially spaced locations 128″ and 128′″. The inside surface 124′″ can taper or have a uniform diameter between the steps at the locations 128′,128″,128′″.

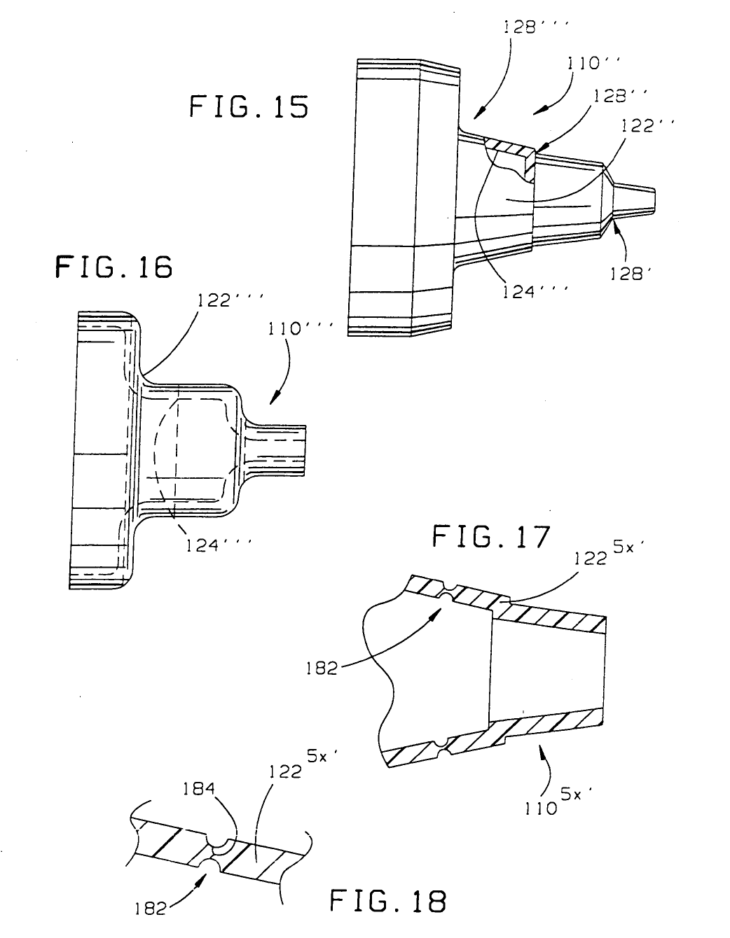

In FIG. 16, a further modified form of discharge assembly is shown at 110′″ with an annular wall 122′″ that is curved to define an inside surface 124′″ having varying diameters.

As shown in FIGS. 17 and 18, a discharge assembly 110^{5x} is shown wherein a weakening is provided at 182 in an annular wall 122^{5x′} which allows the wall 122^{5x′} to be fractured along a line 184 through pressure application by the user. This obviates the need for a separate tool to effect reconfiguration of the annular wall 122^{5x}. Other means to effect weakening of the wall 122^{5x′} are contemplated.

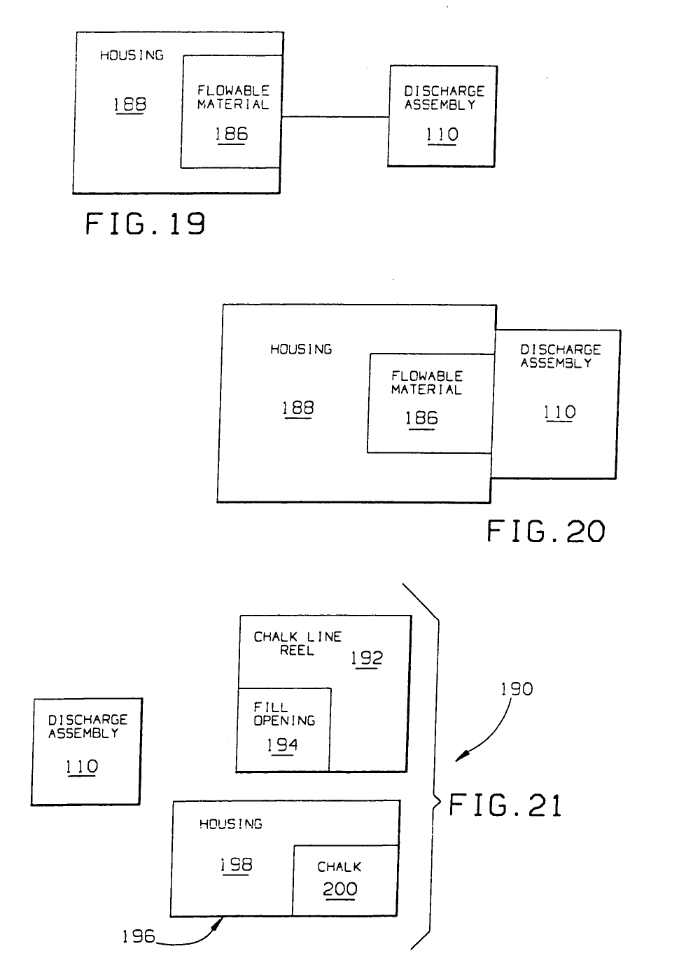

As shown in FIGS. 19 and 20, the invention contemplates using the discharge assembly 110 with any type of flowable material 186 in a container housing 188. The flowable material 186 may be a liquid, a particulate, a powder, etc. The discharge assembly 110 can be separately attached to the housing, as shown in FIG. 19, or an integral part thereof, or permanently attached thereto, as shown in FIG. 20.

As shown in FIG. 21, a kit can be offered, as shown at 190, including a chalk line reel 192 having a fill opening 194, together with a container at 196 consisting of a housing 198 with a supply of chalk 200, together with a discharge assembly 110. The discharge assembly 110 can be separate from, integral with, or permanently attached to, the housing 198.

The discharge assembly 110 can be translucent or transparent to facilitate viewing of the supply of chalk 200 or other flowable material therethrough, primarily to ascertain its color. Alternatively, the discharge assembly 110 can be colored to correspond to the color of a supply of chalk 200 or other flowable material. This facilitates inventorying and product selection by a purveyor or user thereof.

While the description herein refers to the diameter of various passageways and openings, it should be understood that the “diameter” need not be defined precisely by a circle. Other shapes can be used that have an “effective” diameter that is noncircular in nature.

While the invention has been described with particular reference to the drawings, it should be understood that various modifications could be made without departing from the spirit and scope of the present invention.

1. A discharge assembly for a flowable material on a container having a housing with a wall bounding a storage space for flowable material and a fill opening in communication with the storage space, the discharge assembly comprising:
a body defining a connecting portion and a discharge portion,
the connecting portion maintaining the discharge assembly on the container housing,
the discharge portion having an annular wall with an annular inside surface having at least a portion with a diameter that tapers along a central axis in a direction from the connecting portion toward a free end to guide flowable material for discharge toward the free end,
the inside surface of the annular wall having a stepped shape at a first axial location as viewed in cross section defined by a plane containing the central axis so as to define a larger diameter portion between the first location and the connecting portion and a smaller diameter portion between the first location and the free end,
the annular wall cuttable generally along a plane transversely to the central axis to define a first cut end at the larger diameter portion of the inside surface at which a first discharge opening with a first effective diameter can be formed,
the annular wall at least one of (a) having a second discharge opening at the free end with a second effective diameter and (b) cuttable generally along a plane transversely to the central axis to define a second cut end at the smaller diameter portion of the inside surface at which a third discharge opening with a third effective diameter can be formed.

2. The discharge assembly for a flowable material according to claim 1 in combination with a container having a housing with a wall bounding a storage space for a flowable material on which the discharge assembly is maintained.

3. The discharge assembly for a flowable material according to claim 2 further in combination with a supply of flowable material.

4. The discharge assembly for a flowable material according to claim 3 wherein the flowable material is chalk.

5. The discharge assembly for a flowable material according to claim 2 wherein the discharge assembly is permanently maintained on the container housing.

6. The discharge assembly for a flowable material according to claim 2 wherein the discharge assembly is releasably maintained in the container housing.

7. The discharge assembly for a flowable material according to claim 6 wherein the container housing has an annular neck defining a discharge opening and the connecting portion of the discharge assembly is releasably connected to the annular neck to maintain the discharge assembly on the container housing.

8. The discharge assembly for a flowable material according to claim 7 wherein there are cooperating threads on the connecting portion and the annular neck to allow the discharge assembly to be releasably maintained on the container housing.

9. The discharge assembly for a flowable material according to claim 1 in combination with a closure cap that can be releasably maintained in an operative position on the discharge assembly to one of (a) block discharge of flowable material through the second discharge opening and (b) capture flowable material discharged through the first, second, and third discharge openings.

10. The discharge assembly for a flowable material according to claim 9 wherein the closure cap is releasably snap fit to the annular wall on the discharge assembly.

11. The discharge assembly for a flowable material according to claim 10 wherein the annular wall has an outside surface with a first shoulder that faces in a first axial direction and the closure cap has an inside surface with a second shoulder that faces axially oppositely to the first axial direction with the closure cap in the operative position and confronts the first shoulder to resist relative axial movement of the closure cap and the discharge assembly tending to change the closure cap from the operative position.

12. The discharge assembly for a flowable material according to claim 11 wherein at least a part of at least one of the closure cap and discharge assembly is deformable to allow the closure cap and discharge assembly to be relatively axially moved between a fully separated state and a relative axial position wherein the closure cap is in the operative position by movement of the first and second shoulders towards and past each other into a confronting relationship.

13. The discharge assembly for a flowable material according to claim 12 wherein each of the first and second shoulders has an annular shape around the central axis.

14. The discharge assembly for a flowable material according to claim 9 wherein the annular wall on the discharge assembly has an outside surface with at least a portion having a diameter that tapers along the central axis in a direction from the connecting portion toward the free end, the outside surface having a stepped shape at a second location as viewed in cross section defined by a plane containing the central axis so as to define a second larger diameter portion between the second location and the connecting portion and a second smaller diameter portion between the second location and the free end and with the closure cap in the operative position, the closure cap extends continuously from the free end to axially over at least a portion of the second larger diameter portion.

15. The discharge assembly for a flowable material according to claim 14 wherein the inside and outside surfaces of the annular wall have a conforming shape along substantially the entire axial extent of the annular wall.

16. The discharge assembly for a flowable material according to claim 15 wherein the annular wall has a substantially uniform radial thickness along substantially the entire axial extent of the annular wall.

17. The discharge assembly for a flowable material according to claim 16 wherein the annular wall comprises a plastic material.

18. The discharge assembly for a flowable material according to claim 17 wherein the plastic material is translucent.

19. The discharge assembly for a flowable material according to claim 1 wherein the annular wall has a first visible guide line formed thereon in axial coincidence with the larger diameter portion of the inside surface along which the annular wall can be cut to produce a predetermined diameter for the first discharge opening.

20. The discharge assembly for a flowable material according to claim 19 wherein the annular wall has a second visible guide line formed thereon in axial coincidence with the smaller diameter portion of the inside surface along which the annular wall can be cut to produce a predetermined diameter for the third discharge opening.

21. The discharge assembly for a flowable material according to claim 17 wherein the closure cap comprises a plastic material.

22. The discharge assembly for a flowable material according to claim 1 wherein the inside surface has a first taper angle at the smaller diameter portion and a second taper angle at the larger diameter portion and the first and second taper angles are approximately equal.

23. The discharge assembly for a flowable material according to claim 19 wherein the first visible guide line is defined by an annular shoulder.

24. The discharge assembly for a flowable material according to claim 20 wherein the second visible guide line is defined by an annular shoulder.

25. A discharge assembly for a flowable material on a container having a housing with a wall bounding a storage space for flowable material and a fill opening in communication with the storage space, the discharge assembly comprising:
a body defining a connecting portion and a discharge portion,
the connecting portion maintaining the discharge assembly on the container housing,
the discharge portion having an annular wall with an annular inside surface that has a stepped shape at a first location as viewed in cross section defined by a plane containing the central axis so as to define a larger diameter portion between the first location and the connecting portion and a smaller diameter portion between the first location and the free end,
the annular wall cuttable generally along a plane transversely to the central axis to define a first cut end at the larger diameter portion of the inside surface at which a first discharge opening with a first effective diameter can be formed,
the annular wall at least one of (a) having a second discharge opening at the free end with a second effective diameter and (b) cuttable generally along a plane transversely to the central axis to define a second cut end at the smaller diameter portion of the inside surface at which a third discharge opening with a third effective diameter can be formed.

26. The discharge assembly for a flowable material according to claim 25 in combination with a container having a housing with a wall bounding a storage space for a flowable material on which the discharge assembly is maintained.

27. The discharge assembly for a flowable material according to claim 26 further in combination with a supply of flowable material.

28. The discharge assembly for a flowable material according to claim 27 wherein the flowable material is chalk.

29. The discharge assembly for a flowable material according to claim 25 in combination with a closure cap that can be releasably maintained in an operative position on the discharge assembly to one of (a) block discharge of flowable material through the second discharge opening and (b) capture flowable material discharged through the first, second and third discharge openings.

30. The discharge assembly for a flowable material according to claim 29 wherein the closure cap is releasably snap fit to the annular wall on the discharge assembly.
